(19) United States
(12) Patent Application Publication
(10) Pub. No.: US 2018/0262748 A1
(43) Pub. Date: Sep. 13, 2018

(54) CAMERA CALIBRATION BOARD, CAMERA CALIBRATION DEVICE, CAMERA CALIBRATION METHOD, AND PROGRAM-RECORDING MEDIUM FOR CAMERA CALIBRATION

(71) Applicants: NEC Corporation, Tokyo (JP); TOKYO INSTITUTE OF TECHNOLOGY, Tokyo (JP)

(72) Inventors: Takashi SHIBATA, Tokyo (JP); Masayuki TANAKA, Tokyo (JP); Masatoshi OKUTOMI, Tokyo (JP)

(73) Assignees: NEC Corporation, Tokyo (JP); TOKYO INSTITUTE OF TECHNOLOGY, Tokyo (JP)

(21) Appl. No.: 15/763,613

(22) PCT Filed: Sep. 26, 2016
(86) PCT No.: PCT/JP2016/004338

§ 371 Date: Mar. 27, 2018

(30) Foreign Application Priority Data
Sep. 29, 2015 (JP) 2015-191417

(51) Int. Cl. H04N 13/246; H04N 5/33; H04N 13/257; H04N 9/73

(52) U.S. Cl. CPC H04N 13/246; H04N 5/33; H04N 2013/0077; H04N 9/735; H04N 13/257

(57) ABSTRACT

A camera calibration board, which is arranged three-dimensionally above a board, includes the board, a plurality of flat plates, and a plurality of support columns having the same length. The plurality of flat plates are spatially arranged in a plane different from a plane in which the board is arranged. The board and each of the plurality of flat plates have different reflectances with respect to visible light. With this configuration, it is possible to accurately measure extrinsic parameters between cameras, which are required for calibrating cameras that use different types of image sensors, in order to easily analyze a group of images acquired from a plurality of sensors.

### TECHNICAL FIELD

This invention relates to a camera calibration board, a camera calibration device, a camera calibration method, and a camera calibration program recording medium.

### BACKGROUND ART

In recent years, in order to photograph various objects to be photographed, cameras that use sensors suited to their respective purposes have become widespread. For example, in order to monitor a person or the like, a monitoring camera that uses a visible light sensor has become widespread. Meanwhile, an inexpensive depth image acquisition camera (hereinafter also referred to as “depth camera”) for acquiring a depth image has also become widespread. In addition, in order to monitor a person or the like in the nighttime, a camera that uses an invisible light sensor, such as a near-infrared camera or a far-infrared camera, has also become widespread.

In order to easily analyze a group of images acquired from a plurality of sensors, it is required to calibrate cameras that use different types of image sensors. More specifically, it is required to accurately measure intrinsic parameters representing lens distortion, an image center, and the like of each camera, and extrinsic parameters representing a relative positional relationship between cameras. Against such a background, as the related art, in Non Patent Document 1, there is disclosed a method of simultaneously calibrating cameras through use of a depth image and a visible light image. Further, in Non Patent Document 2, there is disclosed a method of calculating camera's intrinsic parameters from feature points obtained by calculation from images.

There is also known other related art (patent documents), which is related to this invention.

For example, in Patent Document 1, there is disclosed a calibration table to be used for a stereo camera calibration device. The calibration table disclosed in Patent Document 1 comprises a perforated plate, which is arranged on an upper surface of a flat plate, and in which a large number of holes are formed, and a plurality of sticks (calibration poles), which are randomly fitted to freely-selected positions of the large number of holes of the perforated plate. The upper surface of the flat plate is painted in black, an upper surface of the perforated plate is painted in gray, and a top portion of each calibration pole is painted in white. The length of each calibration pole is randomly set. Two cameras (left camera and right camera) are arranged above the calibration table so that optical axes thereof are inclined toward each other. The optical axes of the left camera and the right camera are set so as to be approximately focused on a given point of the calibration table.

Further, in Patent Document 2, there is disclosed a camera parameter estimation apparatus configured to estimate camera parameters of one camera. The camera parameter estimation apparatus disclosed in Patent Document 2 comprises a corresponding point searching device and camera parameter estimation means. The corresponding point searching device searches for a corresponding point between a plurality of images obtained by photographing the same object by one camera. The camera parameter estimation means uses information on the corresponding point, which is input from corresponding point searching means, to perform optimization through bundle adjustment with camera posture coefficients being set as unknown quantities, to thereby estimate the camera parameters.

### PRIOR ART DOCUMENTS

### Patent Document

Patent Document 1: JP H08-086613 A
Patent Document 2: JP 2014-032628 A

### Non Patent Document

Non Patent Document 1: Herrera, C., Juho Kannala, and Janne Heikkilae. “Joint depth and color camera calibration with distortion correction.” Pattern Analysis and Machine Intelligence, IEEE Transactions on 34.10 (2012): 2058-2064.
Non Patent Document 2: Zhang, Zhengyou. “A flexible new technique for camera calibration.” Pattern Analysis and Machine Intelligence, IEEE Transactions on 22.11 (2000): 1330-1334.

### SUMMARY OF THE INVENTION

### Problem to be Solved by the Invention

However, the method of Non Patent Document 1 has a problem of reduced accuracy of bundle adjustment, which is processing of highly accurately measuring extrinsic parameters between cameras from the visible light image and the depth image. The reason is as follows. In general, “bundle adjustment” is processing of calculating camera parameters through total optimization from coordinates of a group of corresponding identical points. However, with the method of Non Patent Document 1, it is difficult to highly accurately obtain coordinate values of a group of corresponding identical points through simple processing from the visible light image and the depth image.

In Non Patent Document 2, there is merely disclosed the method of calculating the camera's intrinsic parameters from the feature points.

Moreover, Patent Documents 1 and 2 have respective problems described below.

In Patent Document 1, there is merely disclosed the calibration table to be used to easily and accurately calibrate spatial positions of the two cameras when an object is photographed with the two cameras. In other words, the calibration table disclosed in Patent Document 1 is used to calibrate the spatial positions of the two cameras of the same type, and is not intended in any way to calibrate a plurality of cameras of different types. Therefore, Patent Document 1 has a different problem to be solved.

In Patent Document 2, there is merely disclosed the camera parameter estimation apparatus configured to estimate the camera parameters of one camera through the bundle adjustment. Also in Patent Document 2, there is no intention of calibrating a plurality of cameras of different types. Therefore, Patent Document 2 has a different problem to be solved.

It is an object of this invention to provide a camera calibration board, a camera calibration device, a camera calibration method, and a camera calibration program recording medium, which are capable of solving the above-mentioned problems.

A mode of this invention is a camera calibration board, comprising: a board; and a plurality of flat plates, which are arranged above the board via a plurality of support columns having the same length, respectively, wherein the plurality of flat plates are spatially arranged in a plane that is different from a plane in which the board is arranged, and wherein the board and each of the plurality of flat plates have different reflectances with respect to visible light.

A camera calibration device according to this invention comprises: a calibration image capturing unit, which includes first through M-th cameras of different types, where M is an integer of 2 or more, which are configured to capture first through M-th calibration images, respectively, through use of the above-mentioned camera calibration board; first through M-th feature point detection units, which are configured to calculate first through M-th feature points from the first through the M-th calibration images, respectively; first through M-th camera parameter estimation units, which are configured to calculate first through to M-th camera parameters for the first through the M-th cameras from the first through the M-th feature points, respectively; and a bundle adjustment unit, which is configured to calculate extrinsic parameters between the first through to the N-th cameras through use of the first through the N-th camera parameters.

A camera calibration method according to this invention comprises: capturing, by first through M-th cameras of different types, where M is an integer of 2 or more, first through M-th calibration images, respectively, through use of the above-mentioned camera calibration board; calculating, by first through M-th feature point detection units, first through M-th feature points from the first through the M-th calibration images, respectively; calculating, by first through M-th camera parameter estimation units, first through M-th camera parameters for the first through the M-th cameras from the first through the M-th feature points, respectively; and calculating, by a bundle adjustment unit, extrinsic parameters between the first through the M-th cameras through use of the first through the M-th camera parameters.

A camera calibration program recording medium according to this invention is a medium having recorded thereon a camera calibration program for causing a computer to execute the procedures of: calculating first through M-th feature points from first through M-th calibration images, respectively, where M is an integer of 2 or more, which are captured by first through M-th cameras of different types, respectively, through use of the above-mentioned camera calibration board; calculating first through M-th camera parameters for the first through the M-th cameras from the first through the M-th feature points, respectively; and calculating extrinsic parameters between the first through the M-th cameras through use of the first through the M-th camera parameters.

### Effect of the Invention

According to this invention, it is possible to highly accurately measure the extrinsic parameters between cameras, which are required for calibrating a plurality of cameras of different types.

### BRIEF DESCRIPTION OF THE DRAWING

FIG. 1 is a schematic diagram of a camera calibration board according to one example embodiment of this invention.

FIG. 2 is a block diagram for illustrating a schematic configuration of a camera calibration device according to Example of this invention.

FIG. 3 is a flowchart for illustrating an operation of the camera calibration device illustrated in FIG. 2.

FIG. 4 is a drawing (photograph) for illustrating an example of a calibration image (visible light image) captured by a visible light camera of a calibration image capturing unit, which is to be used in the camera calibration device illustrated in FIG. 2.

FIG. 5 is a drawing (photograph) for illustrating an example of a calibration image (far-infrared image) captured by a far-infrared camera of the calibration image capturing unit, which is to be used in the camera calibration device illustrated in FIG. 2.

### MODES FOR EMBODYING THE INVENTION

### First Example Embodiment

Next, a first example embodiment of this invention will be described in detail with reference to the drawings.

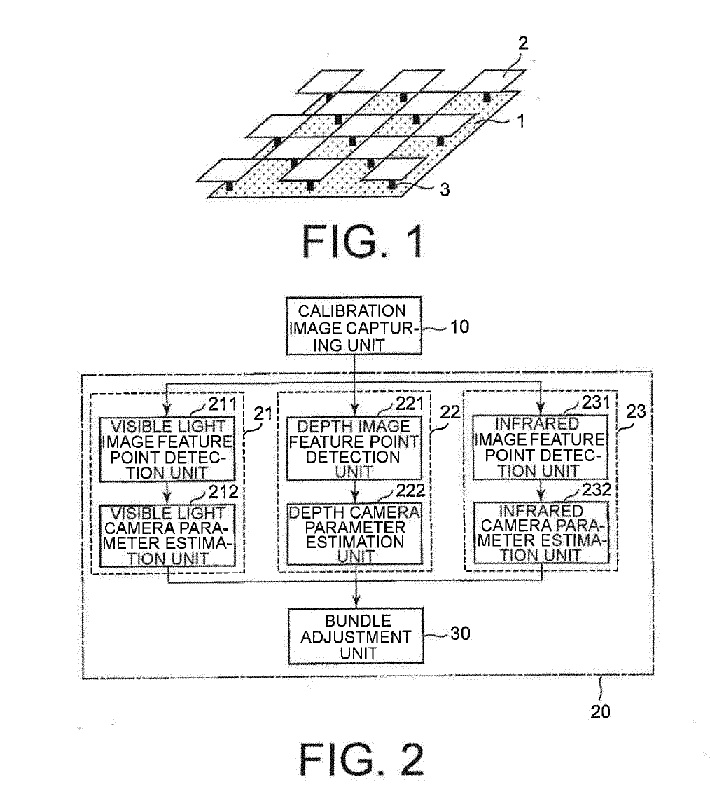

Referring to FIG. 1, a camera calibration board to be used in the first example embodiment of this invention comprises a board 1, a plurality of flat plates 2, and a plurality of support columns 3. The plurality of support columns 3 have the same length. The plurality of flat plates 2 are arranged three-dimensionally above the board 1 via the respective corresponding support columns 2. In this case, each of the plurality of flat plates 2 is formed of a rectangular plate, and the plurality of flat plates 2 are spatially arranged in a plane. In the following, a case in which the board 1 is flat is described, but this invention is not limited thereto. In other words, it is only required that the plurality of flat plates 2 be spatially arranged in a certain plane that is separated from the board 1 by a predetermined distance.

Further, in the camera calibration board to be used in the first example embodiment of this invention, the board 1 and each of the plurality of flat plates 2 have different reflectances with respect to visible light. For example, for the board 1, a white material or a material that has a color other than white and has a surface thereof painted with, for example, white paint or resin is used. In this case, for each of the flat plates 2, a material having a color other than white or a material having a surface thereof painted with, for example, paint or resin having a color other than white is used.

As another example, for each of the flat plates 2, a white material or a material that has a color other than white and has a surface thereof painted with, for example, white paint or resin is used. In this case, for the board 1, a material having a color other than white or a material having a surface thereof painted with, for example, paint or resin having a color other than white is used.

More generally, in the camera calibration board to be used in the first example embodiment of this invention, for the board 1, a material having a given color (hereinafter referred to as “color A”) or a material that has a color other than the color A and has a surface thereof painted with, for example, paint or resin having the color A is used. In this case, for each of the flat plates 2, a material having a color other than the color A or a material having a surface thereof painted with, for example, paint or resin having a color other than the color A is used.

In this invention, when each of the flat plates 2 comprises a flat plate having a certain thickness, a surface of each of the flat plates 2 that is opposed to the board 1 may be chamfered.

In any case, it is only required that the board 1 and each of the plurality of flat plates 2 have different reflectances with respect to visible light, and this invention is not limited to the above-mentioned configuration.

In the first example embodiment, a calibration image capturing unit of a camera calibration device to be described later captures first and second calibration images through use of the camera calibration board described above. The calibration image capturing unit comprises a visible light camera configured to capture a visible light image as the first calibration image through use of the camera calibration board, and a depth camera configured to capture a depth image as the second calibration image through use of the camera calibration board.

Next, effects of the first example embodiment will be described.

According to the first example embodiment of this invention, it is possible to provide the camera calibration device capable of highly accurately measuring extrinsic parameters between cameras, which are required for calibrating the depth camera and the visible light camera from the visible light image acquired from the visible light camera and the depth image acquired from the depth camera. The reason is that, through use of the camera calibration board described in the first example embodiment, the board 1 and the plurality of flat plates 2 are located in planes different from each other and have different reflectances with respect to visible light, and hence a group of points arranged in the plane existing on the plurality of flat plates 2 can be highly accurately extracted from the visible light image and the depth image.

### Second Example Embodiment

Now, a second example embodiment of this invention will be described in detail with reference to the drawings.

Referring to FIG. 1, in a camera calibration board to be used in the second example embodiment of this invention, in addition to the configurations described above in the first example embodiment, the board 1 and the plurality of flat plates 2 are caused to have different temperatures, and the board 1 and the plurality of flat plates 2 are processed so that heat is not transferred therebetween. For example, in the camera calibration board, the plurality of flat plates 2 may be heated (or cooled) so that the board 1 and the plurality of flat plates 2 have different temperatures. As another example, in the camera calibration board, the board 1 may be heated (or cooled) so that the board 1 and the plurality of flat plates 2 have different temperatures.

Further, for the board 1 or each of the plurality of flat plates 2 to be heated (or cooled), a material having a high thermal conductivity and a high thermal radiation property may be used so that the material has a uniform temperature. As another example, in order to achieve both a high thermal conductivity and a high thermal radiation property, the board 1 or each of the plurality of flat plates 2 may have a structure in which a material having a high thermal radiation property is layered on a material having a high thermal conductivity. More specifically, aluminum or other such metal may be used as a material having a high thermal conductivity, and as a material having a high thermal radiation property, resin or the like may be painted as paint on the material having a high thermal conductivity. As another example, in order to increase the thermal radiation property of aluminum or the like, a surface of the metal may be subjected to, for example, anodizing treatment, and the resultant may be used as the board 1 or each of the plurality of flat plates 2.

Further, as a method of heating the board 1 or each of the plurality of flat plates 2, for example, an electric heating wire or other such object may be brought into contact with or built into the board 1 or each of the plurality of flat plates 2 to be heated, and current may be caused to flow through the electric heating wire to heat the board 1 or each of the plurality of flat plates 2. As other examples of the method of heating the board 1 or each of the plurality of flat plates 2, an object having a high or low temperature may be placed around the board 1 or each of the plurality of flat plates 2 to heat or cool the board 1 or each of the plurality of flat plates 2, or, for example, hot air or cold air may be used to heat or cool the board 1 or each of the plurality of flat plates 2.

Still further, the structure in which the plurality of support columns 3 support the board 1 and the plurality of flat plates 2 with space therebetween is formed such that the board 1 and the plurality of flat plates 2 do not transfer heat therebetween. For example, for each of the support columns 3, a material having a low thermal conductivity may be used to support the board 1 and one of the plurality of flat plates 2 with space therebetween. As a material having a low thermal conductivity, for example, resin, plastic, wood, glass, expanded polystyrene, phenolic foam, or rigid polyurethane foam may be used. This invention is not limited thereto, and any material having a low thermal conductivity can be used.

The camera calibration board to be used in the example embodiments of this invention can be used in any environment. For example, the camera calibration board may be used indoors, or may be used outdoors.

In the second example embodiment, a calibration image capturing unit of a camera calibration device to be described later captures first through third calibration images through use of the camera calibration board described above. The calibration image capturing unit comprises a visible light camera configured to capture a visible light image as the first calibration image through use of the camera calibration board, a depth camera configured to capture a depth image as the second calibration image through use of the camera calibration board, and a far-infrared camera configured to capture a far-infrared image as the third calibration image through use of the camera calibration board.

Next, effects of the second example embodiment will be described.

According to the second example embodiment of this invention, it is possible to provide the camera calibration device capable of highly accurately measuring extrinsic parameters between cameras, which are required for simultaneously calibrating the depth camera, the far-infrared camera, and the visible light camera. The reason is that, through use of the camera calibration board to be used in the second example embodiment of this invention, the board 1 and the plurality of flat plates 2 are positioned in different planes, have different reflectances with respect to visible light, and have different temperatures, and hence a group of points arranged in the plane existing on the plurality of flat plates 2 can be highly accurately extracted from the visible light image, the depth image, and the far-infrared image.

### Example

Now, Example of this invention will be described. In the following, an example is described in which processing is configured through use of image processing using the camera calibration board described in the above-mentioned first and second example embodiments, but this invention is not limited thereto.

Referring to FIG. 2, a camera calibration device according to one Example of this invention comprises a calibration image capturing unit 10 and a computer (central processing unit; processor; data processing unit) 20 configured to operate under program control. The computer (central processing unit; processor; data processing unit) 20 comprises a visible light camera calibration unit 21, a depth camera calibration unit 22, an infrared camera calibration unit 23, and a bundle adjustment unit 30.

Further, the visible light camera calibration unit 21 comprises a visible light image feature point detection unit 211 and a visible light camera parameter estimation unit 212. Similarly, the depth camera calibration unit 22 comprises a depth image feature point detection unit 221 and a depth camera parameter estimation unit 222. Moreover, the infrared camera calibration unit 23 comprises an infrared image feature point detection unit 231 and an infrared camera parameter estimation unit 232.

The visible light image feature point detection unit 211, the depth image feature point detection unit 221, and the infrared image feature point detection unit 231 are also referred to as “first feature point detection unit”, “second feature point detection unit”, and “third feature point detection unit”, respectively. Further, the visible light camera parameter estimation unit 212, the depth camera parameter estimation unit 222, and the infrared camera parameter estimation unit 232 are also referred to as “first camera parameter estimation unit”, “second camera parameter estimation unit”, and “third camera parameter estimation unit”, respectively.

Now, details of the respective components will be described.

In the following, a method is described in which all of the visible light camera, the depth camera, and the far-infrared camera are used to construct the calibration image capturing unit 10, but this invention is not limited thereto. For example, the calibration image capturing unit 10, which uses the camera calibration board according to the example embodiments of this invention, may comprise only the visible light camera and the depth camera, comprise only the visible light camera and the far-infrared camera, or comprise only the far-infrared camera and the depth camera.

The visible light camera, the depth camera, and the far-infrared camera are also referred to as “first camera”, “second camera”, and “third camera”, respectively.

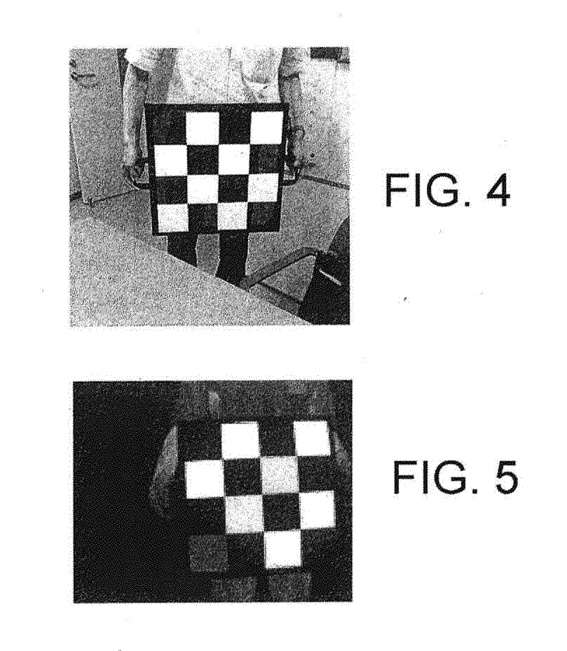

The calibration image capturing unit 10 acquires a plurality of calibration images through use of the camera calibration board described in the above-mentioned example embodiments of this invention. More specifically, after the board 1 or the plurality of flat plates 2 are heated, the plurality of calibration images may be captured by the visible light camera, the depth camera, and the far-infrared camera simultaneously in a plurality of postures as illustrated in FIG. 4 and FIG. 5, for example.

FIG. 4 is a drawing for illustrating an example of the first calibration image (visible light image) captured by the visible light camera. FIG. 5 is a drawing for illustrating an example of the third calibration image-(far-infrared image) captured by the far-infrared camera.

When the images are captured in a plurality of postures, the camera calibration board illustrated in FIG. 1 may be inclined with respect to an optical axis of each camera. For example, regarding the number of images to be captured, each camera may capture about 20 images. The captured images are stored in a memory (not shown).

In the above, the case in which the calibration image capturing unit 10 newly captures calibration images is described, but this invention is not limited thereto. For example, calibration images that have been captured in advance and stored in the memory (not shown) may be read out. As another example, calibration images that have been captured in advance and calibration images that are newly captured by the calibration image capturing unit 10 may be stored in the memory (not shown).

Referring back to FIG. 2, next, the images (visible light image, depth image, and far-infrared image) captured by the respective cameras (visible light camera, depth camera, and far-infrared camera) are supplied to the visible light camera calibration unit 21, the depth camera calibration unit 22, and the infrared camera calibration unit 23, respectively. The visible light image feature point detection unit 211, the depth image feature point detection unit 221, and the infrared image feature point detection unit 231 detect first through third feature points from the visible light image, the depth image, and the far-infrared image, respectively, which are to be used in the visible light camera parameter estimation unit 212, the depth camera parameter estimation unit 222, and the infrared camera parameter estimation unit 232, respectively.

More specifically, for example, the visible light image feature point detection unit 211 detects from the visible light image (first calibration image) an intersection point on a checkered pattern of the plurality of flat plates 2 as the first feature point. As a method of detecting the first feature point, the Harris corner detection algorithm may be used, for example. Further, in order to calculate coordinates of the first feature point more accurately, the visible light image feature point detection unit 211 may use, for example, parabola fitting to detect the first feature point with subpixel accuracy.

Further, first, as pre-processing, the depth image feature point detection unit 221 calculates a plane of the board 1 from the depth image (second calibration image), and converts a pixel value of each image into a value of a distance from the calculated plane. After that, in the same manner as in the visible light image feature point detection unit 211, the depth image feature point detection unit 221 may use, for example, the Harris corner detection algorithm to calculate coordinates of the second feature point.

Further, as pre-processing, the infrared image feature point detection unit 231 removes noise of the far-infrared image (third calibration image), for example. After that, in the same manner as in the visible light image feature point detection unit 211, the infrared image feature point detection unit 231 may use, for example, the Harris corner detection algorithm to calculate coordinates of the third feature point.

The method of detecting a feature point in this invention is not limited to the above-mentioned methods. For example, template matching or other such method may be used to detect a corner. As another example of the method of detecting a feature point in this invention, edge detection processing may be performed to detect edges of the checkered pattern, and then an intersection point of the edges may be detected as a corner.

Next, the visible light camera parameter estimation unit 212, the depth camera parameter estimation unit 222, and the infrared camera parameter estimation unit 232 calculate first through third camera parameters of the respective cameras from the calculated coordinates of the first through the third feature points of the images, respectively.

A more specific description is given taking the visible light image as an example. The visible light camera parameter estimation unit 212 may calculate intrinsic parameters of the visible light camera as the first camera parameter from the calculated first feature point (coordinates of the intersection on the checkered pattern) through use of, for example, the method described in Non Patent Document 2. More specifically, the visible light camera parameter estimation unit 212 may use a camera model described in Non Patent Document 2 to calculate intrinsic parameters of the camera model as the first camera parameter so that a reprojection error obtained from the calculated coordinates of the first feature point is minimized.

In the above-mentioned Example, the method of calculating only the intrinsic parameters of the camera as the first camera parameter is described, but this invention is not limited thereto. For example, the visible light camera parameter estimation unit 212 may calculate lens distortion of the visible light camera at the same time as well as the intrinsic parameters, and correct the camera distortion. As another example, the visible light camera parameter estimation unit 212 may perform bundle adjustment for each camera from the coordinates of the first feature point acquired from the visible light camera, to thereby more accurately calculate intrinsic parameters, lens distortion, and extrinsic parameters as the first camera parameter. More specifically, the visible light camera parameter estimation unit 212 may use the camera model described in Non Patent Document 2 to calculate the intrinsic parameters, lens distortion, and extrinsic parameters of the camera model as the first camera parameter so that a reprojection error obtained from the calculated coordinates of the first feature point is minimized.

Further, the depth camera parameter estimation unit 222 and the infrared camera parameter estimation unit 232 may calculate the second and third camera parameters by the same method that is used in the visible light camera parameter estimation unit 212. As another example, the depth camera parameter estimation unit 222 and the infrared camera parameter estimation unit 232 may calculate the second and third camera parameters through use of a model obtained by modeling characteristics of each camera more finely. For example, when the depth camera is taken as an example for description, the depth camera parameter estimation unit 222 may use a camera model described in Non Patent Document 1 to calculate intrinsic parameters and lens distortion of the depth camera as the second camera parameter.

The bundle adjustment unit 30 calculates extrinsic parameters between the cameras through use of the coordinates of the first through the third feature points extracted by the visible light image feature point detection unit 211, the depth image feature point detection unit 221, and the infrared image feature point detection unit 231, respectively, and the first through the third camera parameters (values of intrinsic parameters and lens distortion of each camera) calculated by the visible light camera parameter estimation unit 212, the depth camera parameter estimation unit 222, and the infrared camera parameter estimation unit 232, respectively. More specifically, the bundle adjustment unit 30 may calculate the extrinsic parameters between the cameras so that a reprojection error obtained from the coordinates of the first through the third feature points extracted by the visible light image feature point detection unit 211, the depth image feature point detection unit 221, and the infrared image feature point detection unit 231, respectively, is minimized.

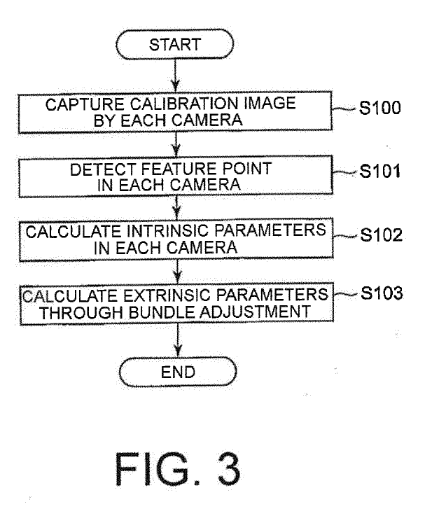

Next, with reference to a flowchart of FIG. 3, an overall operation of the camera calibration device according to this Example will be described in detail.

First, the respective cameras (visible light camera, depth camera, and far-infrared camera) capture the first through the third calibration images through use of the calibration board (S100).

Next, the visible light image feature point detection unit 211, the depth image feature point detection unit 221, and the infrared image feature point detection unit 231 detect the first through the third feature points in the respective cameras (S101).

Next, the visible light camera parameter estimation unit 212, the depth camera parameter estimation unit 222, and the infrared camera parameter estimation unit 232 calculate the first through the third camera parameters (intrinsic parameters) of the respective cameras from the coordinates of the first through the third feature points of images calculated for the respective cameras, respectively (S102).

Further, the bundle adjustment unit 30 uses the first through the third camera parameters (values of intrinsic parameters and lens distortion of respective cameras) calculated by the visible light camera parameter estimation unit 212, the depth camera parameter estimation unit 222, and the infrared camera parameter estimation unit 232, respectively, to optimize the extrinsic parameters so that a reprojection error obtained from the extracted coordinates of the first through the third feature points is minimized, to thereby calculate the extrinsic parameters between the cameras (S103).

In the above-mentioned Example, the case in which the calibration image capturing unit 10 comprises the visible light camera, the depth camera, and the far-infrared camera is taken as an example for description, but the calibration image capturing unit 10 may comprise only the visible light camera and the depth camera. In this case, the computer (central processing unit; processor; data processing unit) 20 is not required to include the infrared camera calibration unit 23. That is, the computer (central processing unit; processor; data processing unit) 20 comprises the visible light camera calibration unit 21, the depth camera calibration unit 22, and the bundle adjustment unit 30.

The respective units of the camera calibration device are only required to be implemented through use of a combination of hardware and software. In a mode in which hardware and software are combined, a camera calibration program is loaded onto a random access memory (RAM), and a control unit (central processing unit (CPU)) and other hardware are caused to operate based on the program, to thereby implement each unit as corresponding means. Further, the program may be recorded in a recording medium for distribution. The program recorded in the recording medium is read into a memory in a wired or wireless manner, or via the recording medium itself, to cause the control unit and the like to operate. Examples of the recording medium include an optical disc, a magnetic disk, a semiconductor memory device, and a hard disk.

When the example embodiments described above are described in another expression, the example embodiments can be implemented by causing, based on the camera calibration program loaded onto the RAM, a computer that is caused to operate as the camera calibration device to operate as the visible light camera calibration unit 21, the depth camera calibration unit 22, the infrared camera calibration unit 23, and the bundle adjustment unit 30.

As described above, according to the Example of this invention, it is possible to highly accurately measure the extrinsic parameters between cameras, which are required for calibrating cameras of different types.

Further, specific configurations of this invention are not limited to those of the above-mentioned example embodiments (Example), and this invention encompasses modifications that do not depart from the gist of this invention. For example, in the above-mentioned Example, the case is described in which three types of cameras including the visible light camera, the depth camera, and the far-infrared camera are used as different types of cameras, but it should be understood that this invention is similarly applicable also to a case in which four or more types of cameras are used.

In the above, the invention of this application is described with reference to the example embodiments (Example), but the invention of this application is not limited to the above-mentioned example embodiments (Example). Various modifications that may be understood by a person skilled in the art can be made to the configurations and details of the invention of this application within the scope of the invention of this application.

This application is based upon and claims the benefit of priority from Japanese Patent Application No. 2015-191417, filed on Sep. 29, 2015, the disclosure of which is incorporated herein in its entirety by reference.

### REFERENCE SIGNS LIST

1 board
2 flat plate
3 support column
10 calibration image capturing unit
20 computer (central processing unit; processor; data processing unit)
21 visible light camera calibration unit
211 visible light image feature point detection unit
212 visible light camera parameter estimation unit
22 depth camera calibration unit
221 depth image feature point detection unit
222 depth camera parameter estimation unit
23 infrared camera calibration unit
231 infrared image feature point detection unit
232 infrared camera parameter estimation unit
30 bundle adjustment unit

1. A camera calibration board, comprising:
a board; and
a plurality of flat plates, which are arranged above the board via a plurality of support columns having the same length, respectively,
wherein the plurality of flat plates are spatially arranged in a plane that is different from a plane in which the board is arranged, and
wherein the board and each of the plurality of flat plates have different reflectances with respect to visible light.

2. The camera calibration board according to claim 1, wherein each of the plurality of flat plates has a rectangular shape.

3. The camera calibration board according to claim 1, wherein the board and each of the plurality of flat plates are heated or cooled to have different temperatures, and are processed so that heat is prevented from being transferred between the board and the each of the plurality of flat plates.

4. The camera calibration board according to claim 3, wherein the board or each of the plurality of flat plates to be heated or cooled includes a material having a high thermal conductivity and a high thermal radiation property.

5. The camera calibration board according to claim 3, wherein the board or each of the plurality of flat plates to be heated or cooled includes:
a material having a high thermal conductivity; and
a material having a high thermal radiation property, which is layered on the material having a high thermal conductivity.

6. The camera calibration board according to claim 3, wherein the board or each of the plurality of flat plates to be heated or cooled has built therein or attached thereto an object for heating or cooling the board or the each of the plurality of flat plates to be heated or cooled.

7. The camera calibration board according to claim 3, wherein each of the plurality of support columns includes a material having a low thermal conductivity.

8. A camera calibration device, comprising:
a calibration image capturing circuitry, which includes first and second cameras of different types, which are configured to capture first and second calibration images, respectively, through use of the camera calibration board of claim 1;
first and second feature point detection circuitry, which are configured to calculate first and second feature points from the first and the second calibration images, respectively;
first and second camera parameter estimation circuitry, which are configured to calculate first and second camera parameters for the first and the second cameras from the first and the second feature points, respectively; and
a bundle adjustment circuitry, which is configured to calculate extrinsic parameters between the first and the second cameras through use of the first and the second camera parameters.

9. The camera calibration device according to claim 8,
wherein the first camera comprises a visible light camera, and the first calibration image comprises a visible light image, and
wherein the second camera comprises a depth camera, and the second calibration image comprises a depth image.

10. A camera calibration device, comprising:
a calibration image capturing circuitry, which includes first through N-th cameras of different types, where N is an integer of 3 or more, which are configured to capture first through N-th calibration images, respectively, through use of the camera calibration board of claim 3;
first through N-th feature point detection circuitry, which are configured to calculate first through N-th feature points from the first through the N-th calibration images, respectively;
first through N-th camera parameter estimation circuitry, which are configured to calculate first through to N-th camera parameters for the first through the N-th cameras from the first through the N-th feature points, respectively; and
a bundle adjustment circuitry, which is configured to calculate extrinsic parameters between the first through to the N-th cameras through use of the first through the N-th camera parameters.

11. The camera calibration device according to claim 10,
wherein the integer N is equal to 3,
wherein the first camera comprises a visible light camera, and the first calibration image comprises a visible light image,
wherein the second camera comprises a depth camera, and the second calibration image comprises a depth image, and
wherein the third camera comprises a far-infrared camera, and the third calibration image comprises a far-infrared image.

12. A camera calibration method, comprising:
capturing, by first through M-th cameras of different types, where M is an integer of 2 or more, first through M-th calibration images, respectively, through use of the camera calibration board of claim 1;
calculating first through M-th feature points from the first through the M-th calibration images, respectively;
calculating first through M-th camera parameters for the first through the M-th cameras from the first through the M-th feature points, respectively; and
calculating extrinsic parameters between the first through the M-th cameras through use of the first through the M-th camera parameters.

13. A camera calibration program recording medium having recorded thereon a camera calibration program for causing a computer to execute the procedures of:
calculating first through M-th feature points from first through M-th calibration images, respectively, where M is an integer of 2 or more, which are captured by first through M-th cameras of different types, respectively, through use of the camera calibration board of claim 1;
calculating first through M-th camera parameters for the first through the M-th cameras from the first through the M-th feature points, respectively; and
calculating extrinsic parameters between the first through the M-th cameras through use of the first through the M-th camera parameters.
